(19) United States
(12) Patent Application Publication
(10) Pub. No.: US 2017/0328990 A1
(43) Pub. Date: Nov. 16, 2017

(54) SCALABLE FIELD OF VIEW SCANNING IN OPTICAL DISTANCE MEASUREMENT SYSTEMS

(71) Applicant: TEXAS INSTRUMENTS INCORPORATED, Dallas, TX (US)

(72) Inventors: David P. MAGEE, Allen, TX (US); Nirmal C. WARKE, Saratoga, CA (US); Stephen Aldridge SHAW, Plano, TX (US); Terry Alan BARTLETT, Dallas, TX (US); Rick ODEN, McKinney, TX (US)

(73) Assignee: TEXAS INSTRUMENTS INCORPORATED, Dallas, TX (US)

(21) Appl. No.: 15/592,921

(22) Filed: May 11, 2017

Related U.S. Application Data
(60) Provisional application No. 62/334,728, filed on May 11, 2016.

(51) Int. Cl. G01S 7/481; G01S 17/10; G01S 7/486; G01S 17/93; G01S 7/484

(52) U.S. Cl. CPC G01S 7/4817; G01S 17/936; G01S 7/484; G01S 7/4865; G01S 17/10

(57) ABSTRACT

An optical distance measuring system includes a transmitter, a beam steering device, and a receiver. The transmitter is configured to generate a first plurality of optical waveforms. The beam steering device is configured to steer the first plurality of optical waveforms to a first plurality of scan points that form a non-uniform scan region within a field of view (FOV). The receiver is configured to receive the first plurality of optical waveforms reflected off of a first plurality of target objects within the non-uniform scan region and determine a distance to each target object of the first plurality of target objects based on a time of flight from the transmitter to each target object of the first plurality of target objects and back to the receiver.

### CROSS-REFERENCE TO RELATED APPLICATIONS

The present application claims priority to U.S. Provisional Patent Application No. 62/334,728, filed May 11, 2016, titled “Method of Scalable FOV Scanning in 3D Distance Measuring Systems,” which is hereby incorporated herein by reference in its entirety.

### BACKGROUND

Light Detection And Ranging (LiDAR, LIDAR, lidar, LADAR) is a system that measures the distance to a target object by reflecting a laser pulse sequence (a single narrow pulse or sequence of modulated narrow pulses) off of the target and analyzing the reflected light. More specifically, LiDAR systems typically determine a time of flight (TOF) for the laser pulse to travel from the laser to the target object and return either directly or by analyzing the phase shift between the reflected light signal and the transmitted light signal. The distance to the target object then may be determined based on the TOF. These systems may be used in many applications including: geography, geology, geomorphology, seismology, transport, and remote sensing. For example, in transportation, automobiles may include LiDAR systems to monitor the distance between the vehicle and other objects (e.g., another vehicle). The vehicle may utilize the distance determined by the LiDAR system to, for example, determine whether the other object, such as another vehicle, is too close, and automatically apply braking.

Many LiDAR systems use a rotating optical measurement system to determine distance information for objects in its field of view (FOV). The intensity of the reflected light is measured for several vertical planes through a full 360 degree rotation. However, these systems have limited angular and vertical resolution and require several watts of power to rotate the system. As a result, the spacing of the scan points in the FOV is fixed, thereby defining the resolution of the resulting point cloud image.

### SUMMARY

In accordance with at least one embodiment of the disclosure, an optical distance measuring system includes a transmitter, a beam steering device, and a receiver. The transmitter is configured to generate a first plurality of optical waveforms. The beam steering device is configured to steer the first plurality of optical waveforms to a first plurality of scan points that form a non-uniform scan region within a FOV. The receiver is configured to receive the first plurality of optical waveforms reflected off of a first plurality of target objects within the non-uniform scan region and determine a distance to each target object of the first plurality of target objects based on a time of flight from the transmitter to each target object of the first plurality of target objects and back to the receiver.

Another illustrative embodiment is an optical transmitting system for distance measuring that includes a signal generator, a laser diode coupled to the signal generator, and a beam steering device. The signal generator is configured to generate a first plurality of pulse sequences. The laser diode is configured to generate a first plurality of optical waveforms that correspond with the first plurality of pulse sequences. The beam steering device is configured to receive the first plurality of optical waveforms and steer the first plurality of optical waveforms to a first plurality of scan points that form a non-uniform scan region within a FOV.

Yet another illustrative embodiment is a method for determining a distance to a plurality of target objects. The method includes generating a first plurality of optical waveforms. The method also includes steering the first plurality of optical waveforms to a first plurality of scan points that form a uniform scan region with a FOV. The method also includes, in response to the scan of the uniform scan region, determining a non-uniform scan region within the FOV. The method also includes generating a second plurality of optical waveforms. The method also includes steering the second plurality of optical waveforms to a second plurality of scan points that form the non-uniform scan region.

### BRIEF DESCRIPTION OF THE DRAWINGS

For a detailed description of various examples, reference will now be made to the accompanying drawings in which:

FIG. 1 shows an illustrative optical distance measuring system in accordance with various examples;

FIG. 2A shows an illustrative uniform scan point beam steering methodology to scan a FOV in accordance with various examples;

FIG. 2B shows an illustrative non-uniform scan point beam steering methodology to scan a FOV in accordance with various examples;

FIG. 2C shows an illustrative non-uniform scan point beam steering methodology to scan a FOV in accordance with various examples;

FIG. 3A shows an illustrative transmitting system for an optical distance measuring system in accordance with various examples;

FIG. 3B shows an illustrative transmitting system for an optical distance measuring system in accordance with various examples;

FIG. 3C shows an illustrative transmitting system for an optical distance measuring system in accordance with various examples;

FIG. 4 show an illustrative receiving system for an optical distance measuring system in accordance with various examples; and

FIG. 5 shows an illustrative flow diagram of a method for determining a distance to a plurality of target objects in accordance with various examples.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections. The recitation “based on” is intended to mean “based at least in part on.” Therefore, if X is based on Y, X may be based on Y and any number of other factors.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Optical distance measurement systems, such as LiDAR systems, may determine distances to various target objects utilizing the time of flight (TOF) of an optical signal (i.e., a light signal) to the target object and its reflection off the target object back to the LiDAR system (return signal). These systems may be used in many applications including: geography, geology, geomorphology, seismology, transport, and remote sensing. For example, in transportation, automobiles may include LiDAR systems to monitor the distance between the vehicle and other objects (e.g., another vehicle). The vehicle may utilize the distance determined by the LiDAR system to, for example, determine whether the other object, such as another vehicle, is too close, and automatically apply braking.

As discussed above, many conventional LiDAR systems use a rotating optical measurement system to determine distance information for objects in its FOV. The intensity of the reflected light is measured for several vertical planes through a full 360 degree rotation. For example, these conventional LiDAR systems may use a rotating set of transmit and receive optics. For each scan plane, a light beam is transmitted and received at each angular position of the rotating system (i.e., a light beam is transmitted to a number of scan points in a grid pattern in the FOV and reflected off objects located at the scan points). When complete, a three dimensional (3D) image of the FOV may be generated. However, these systems have limited angular and vertical resolution and require several watts of power to rotate the system. As a result, the spacing of the scan points in the FOV is fixed, thereby defining the resolution of the resulting point cloud image. Therefore, there is a need to develop an optical distance measurement system that increases angular and vertical resolution while reducing power requirements.

In accordance with various examples, an optical distance measuring system is provided in which a beam steering device (e.g., motorized platform attached to a laser, a rotatable mirror, a micromirror device, a phased array device, etc.) is configured to steer optical waveforms to any location within the FOV. In other words, unlike conventional systems, in an embodiment, a distance measuring system may scan non-uniformly and/or arbitrarily within the FOV. Thus, an optical waveform can be focused at any point within the FOV at any given time. As a result, random and/or non-uniform scan patterns can be generated based on application need.

In one example embodiment, the entire FOV is scanned with a uniform scan pattern (e.g., a square and/or rectangular grid of scan points). In an embodiment, the uniform scan provides coarse resolution with a relatively low frame rate. From the uniform scan pattern, the optical distance measuring system identifies objects of interest within the FOV. The system then scans only the objects of interest in a non-uniform manner (e.g., not a square and/or rectangular grid of scan points covering the entire FOV) with a relatively higher resolution and higher frame rate to track the position of the objects of interest over time. The uniform and non-uniform scan patterns can be alternated in time at any desired rate according to the environment the system is running. Thus, the uniform scan pattern may be periodically scanned to determine whether new and/or additional objects should be tracked as part of the non-uniform scan pattern. Furthermore, the non-uniform scan patterns can be updated based on the tracking of the objects in those regions. Thus, resolution of the resulting point cloud images can be increased while power requirements can be reduced.

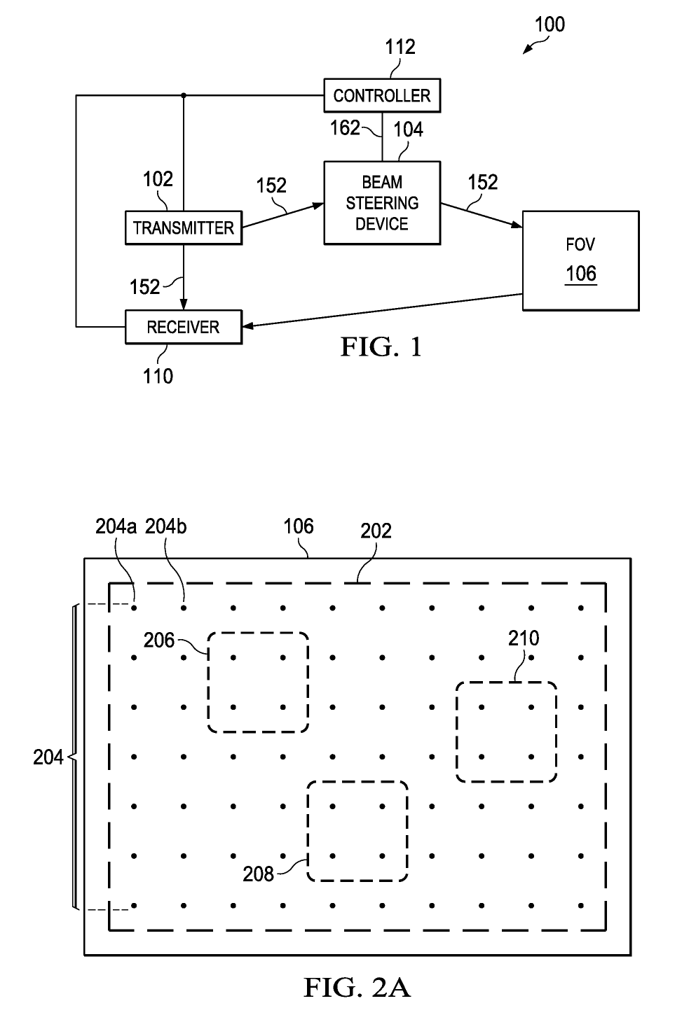

FIG. 1 shows an illustrative optical distance measuring system 100 in accordance with various examples. The distance measuring system 100 includes a transmitter 102, beam steering device 104, receiver 110, and controller 112. The transmitter 102 is configured to generate a plurality of optical waveforms 152 by the controller 112. In some embodiments, the optical waveforms 152 are single tones (e.g., continuous waves), single tones with phase modulation (e.g., phase shift keying), multiple tones with fixed frequencies (e.g., frequency shift keying), signals with frequency modulation over a frequency range (e.g., chirps), and/or signals with narrowband, pulse position modulation.

The beam steering device 104 is configured to receive each of the optical waveforms 152 and steer the optical waveforms 152 to the FOV 106. More particularly, the beam steering device 104 is configured to steer the optical waveforms to a plurality of scan points. For example, the beam steering device 104 is, in an embodiment, configured to steer one optical waveform to a first scan point in the FOV 106 and steer a second optical waveform to a second scan point in the FOV 106. In this way, the beam steering device 104 is capable of scanning one or more scan regions, each containing a number of scan points, within the FOV 106.

In some embodiments, the beam steering device 104 is a solid state device (e.g., a micromirror device, a phased array device, etc.), a motorized platform attached to a laser, and/or a rotatable mirror single chip. In the micromirror device embodiments, the beam steering device 104 has a surface that includes thousands, tens of thousands, hundreds of thousands, millions, etc. microscopic mirrors arranged in an array (e.g., a rectangular array). Each of the mirrors on the beam steering device 104 are capable of rotation, in some embodiments, by plus or minus 10 to 12 degrees. In other embodiments, the mirrors of the beam steering device 104 may be rotated by more or less than plus or minus 10 to 12 degrees. In some embodiments, one or more electrodes (e.g., two pairs) control the position (e.g., the amount of rotation) of each mirror by electrostatic attraction. To rotate the mirrors on the beam steering device 104, the required state for each mirror is loaded into a static random-access memory (SRAM) cell that is located beneath each mirror. The SRAM cell is connected to the electrodes that control the rotation of a particular mirror. The charges in the SRAM cells then move each mirror to the desired position. Controller 112 is configured to provide each SRAM cell with the required charge utilizing control signal 162, and thus, controls the position of each mirror in the beam steering device 104. Based on the position of each mirror, the beam steering device 104 directs the light to form an optical waveform 152 (e.g., optical beam of light) that can be steered to a desired location within the FOV 106 of the system 100. In other words, the mirrors may be positioned to create diffraction patterns causing the beam to steer in two dimensions to a desired location (e.g., a scan point) within the FOV 106.

In another embodiment, the beam steering device 104 is a phased array device using temperature to steer the optical waveform 152. In this phased array device embodiment, the controller 112 controls the temperature of each of a number of wave guides of the beam steering device 104 utilizing control signal 162. The wave guides provide optical paths to form an optical waveform 152. By controlling the temperature of the specific wave guides, each path may be phase delayed. This design enables the beam steering device 104 to steer the optical waveform 152 in two dimensions to a desired location (e.g., a scan point) within the FOV 106.

In another embodiment, the beam steering device 104 is a phased array device using position to steer the optical waveform 152. In this phased array device embodiment, the controller 112 controls the linear or angular position of a number of reflective surfaces of the beam steering device 104 utilizing control signal 162. The reflective surfaces provide optical paths to form an optical waveform 152. By controlling the length and/or orientation of the optical paths, each path may be phase delayed. This design enables the beam steering device 104 to steer the optical waveform 152 in two dimensions to a desired location (e.g., a scan point) within the FOV 106. In further embodiments, the beam steering device 104 may be any solid state device that is capable of steering optical waveforms 152.

In some embodiments, the beam steering device 104 is a motorized platform attached to a laser. In this laser positioning system embodiment, the controller 112 controls the rotation of the laser around a vertical axis and the vertical pitch of the laser utilizing control signal 162. Thus, the laser is capable of being pointed at any desired location (e.g., a scan point) within the FOV 106. The laser then may generate an optical waveform 152 directed at the desired location.

In some embodiments, the beam steering device 104 is a rotatable mirror. In this rotatable mirror embodiment, the controller 112 controls the rotation of the mirror around a vertical axis and the vertical pitch of the mirror utilizing control signal 162. For example, an analog pointing mirror, in some embodiments a microelectromechanical system (MEMS) mirror, is be oriented, by the controller 112, such that it receives the optical waveform 152 from the transmitter 102 and reflects the optical waveform 152 to the desired location (e.g., a scan point) within the FOV 106.

Each optical waveform 152 reflects off of a target object within the FOV 106. Each reflected optical waveform 152 is then received by the receiver 110. In some embodiments, an additional beam steering device (not shown), and in a similar manner to beam steering device 104, steers each reflected optical waveform 152 to the receiver 110. In these embodiments, like the beam steering device 104, the additional beam steering device receives control instructions from controller 112 to configure the additional beam steering device such that each reflected optical waveform 152 is steered to the receiver 110. In alternative embodiments, the beam steering device 104 may be utilized to both steer each optical waveform 152 to a scan point in the FOV 106 and to steer the reflected optical waveform 152 to the receiver 110. In some embodiments, the receiver 110 receives each reflected optical waveform 152 directly from a target object in the FOV 106.

The receiver 110 is configured to receive each reflected optical waveform 152 and determine the distance to objects within the FOV 106 based on the TOF from the transmitter 102 to the target object and back to the receiver 110 of each optical waveform 152. For example, the speed of light is known, so the distance to an object is determined and/or estimated using the TOF. That is, the distance is estimated as d=₂ where d is the distance to the target object, c is the speed of light, and TOF is the time of flight. The speed of light times the TOF is halved to account for the travel of the light pulse to, and from, the object. In some embodiments, the receiver 110, in addition to receiving each reflected optical waveform 152 reflected off an object within the FOV 106, is also configured to receive each optical waveform 152, or a portion of each optical waveform 152, directly from the transmitter 102. The receiver 110, in an embodiment, is configured to convert the optical signals into electrical signals, a received signal corresponding to each reflected optical waveform 152 and a reference signal corresponding to each optical waveform 152 received directly from the transmitter 102. The receiver 110 then, in an embodiment, performs a correlation function using the reference signal and the received signal. A peak in the correlation function corresponds to the time delay of each received reflected optical waveform 152 (i.e., the TOF). The distance then can be estimated using the formula discussed above. In other embodiments, a fast Fourier transform (FFT) can be performed on the received signal. A phase of the tone then is used to estimate the delay (i.e., TOF) in the received signal. The distance then can be estimated using the formula discussed above.

As discussed above, multiple optical waveforms 152 may be generated and, each one directed to a different scan point of the scan region within the FOV 106. Thus, distance information of a target object at each scan point is determined by the system 100. Therefore, the system 100 can provide an “image” based on distance measurements of the scan region within the FOV 106.

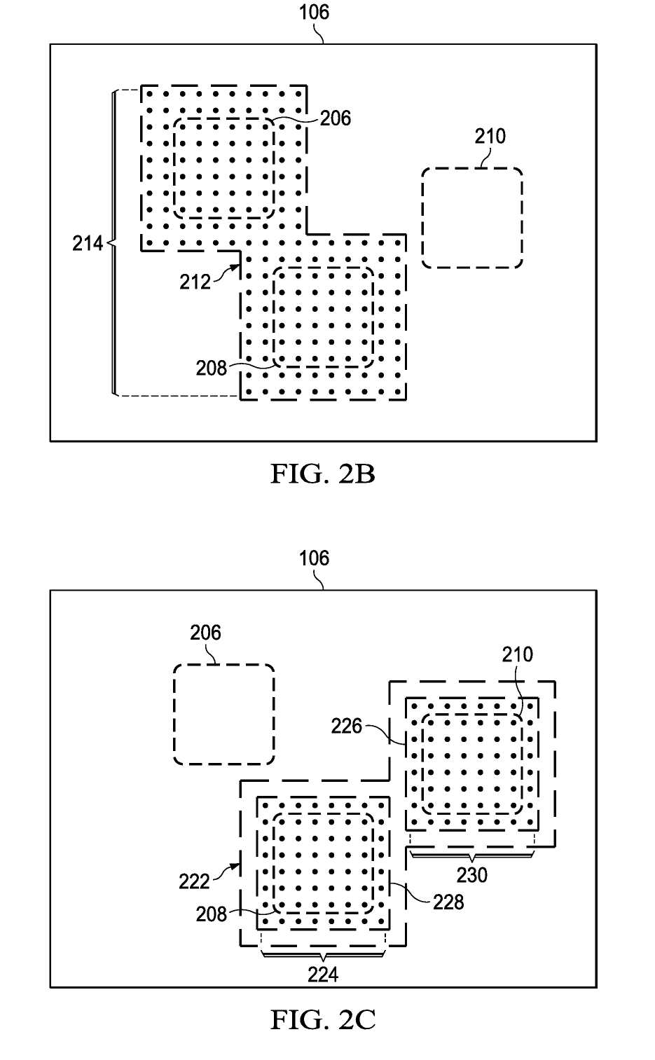

FIG. 2A shows an illustrative uniform scan point beam steering methodology to scan FOV 106 in accordance with various examples. In the example shown in FIG. 2A, the FOV 106 includes a scan region 202. Within the FOV 106 and the scan region 202 are target objects 206, 208, and 210. In an embodiment, the scan region 202 is a rectangular uniform scan region that covers the entire, or most of the FOV 106. The scan region 202 includes multiple scan points 204 that cover the entire scan region 202. Thus, in an embodiment, a first optical waveform 152 is directed, by beam steering device 104, to scan point 204a, and a distance measurement is made to any object located at scan point 204a. A second optical waveform 152 is directed, by beam steering device 104, to scan point 204b, and a distance measurement is made to any object located at scan point 204b. In this way, all of the scan points 204 are scanned and distances to objects, including target objects 206, 208, and 210 are determined. Because the scan region 202 is relatively large (e.g., includes all or most of the FOV 106), in some embodiments, a coarse scan is performed. In other words, the scan of scan region 202 is at a relatively low image resolution (e.g., the scan points 204 are spaced relatively far from one another with a relatively low density). The coarse scan of the scan region 202 then, in an embodiment, is conducted one or more additional times at a relatively low frame rate. In other words, a distance to objects at each scan point 204 is determined at different times. Thus, relative movement of objects within the scan region 202 may be determined.

In some embodiments, the scan of scan region 202 depicted in FIG. 2A is utilized to identify regions of interest. For example, the controller 112, in an embodiment, computes the distance measurements to the objects within the scan region 202 and determines, based on the scan of the uniform scan region 202, what regions of interest within the FOV 106 to further focus on. The controller 112 can be any type of processor, controller, microcontroller, and/or microprocessor with an architecture optimized for processing the distance measurement data received from receiver 110 and controlling the beam steering device 104. For example, the controller 112 may be a digital signal processor (DSP), a central processing unit (CPU), a reduced instruction set computing (RISC) core such as an advanced RISC machine (ARM) core, a mixed signal processor (MSP), etc. In some examples, the regions of interest determined by the controller 112 are based on the relative velocity (e.g., movement) of specific target objects within the scan region with respect to the system 100. For example, if a determination is made that target object 206 and 208 are moving at a relative velocity above a threshold level with respect to the system 100, the controller 112 determines that the regions surrounding the target objects 206 and 208 are regions of interest. In some embodiments, the coarse scan, discussed above to identify regions of interest within the FOV 106 is completed utilizing a radar system or other camera system with results provided to the controller 112 to determine the regions of interest.

FIG. 2B shows an illustrative non-uniform scan point beam steering methodology to scan FOV 106 in accordance with various examples. In the example shown in FIG. 2B, the FOV 106 includes a scan region 212. Within the scan region 212 is target objects 206 and 208 while target object 210 is within the FOV 106, but outside the scan region 212. In other words, the scan region 212 is focused on target objects 206 and 208. Due to the capability of the beam steering device 104 to steer the optical waveforms 152 to any location within the FOV 106 at any time, the scan region 212 need not be uniform, but may be any shape (e.g., the shape of scan region 212) enabling the system 100 to focus on specific objects (e.g., target objects 206 and 208) and/or groups of objects within the FOV 106. In the example shown in FIG. 2B, the scan region 212 is a non-uniform scan region that covers approximately half of the FOV 106. This capability enables the system 100 to track a group of objects (target objects 206 and 208) within the FOV 106.

Like the scan region 202, the scan region 212 includes multiple scan points 214 that cover the entire scan region 212. All of the scan points 214 are scanned and distances to the target objects 206 and 208 are determined. Because the scan region 212 is relatively small (e.g., includes approximately half of the FOV 106 and half the size of scan region 202), in some embodiments, a fine scan is performed. In other words, the scan of scan region 212 is at a relatively high image resolution (e.g., the scan points 214 are spaced relatively close to one another with a relatively high density). The fine scan of the scan region 212 then, in an embodiment, is conducted one or more additional times at a relatively high frame rate (e.g., a higher frame rate than the frame rate used during the coarse scan). Thus, relative movement of objects within the scan region 212 may be determined with greater accuracy than with the coarse scan of scan region 202 discussed above. Furthermore, a higher resolution “image” of the scan region 212 is obtained.

In some embodiments, the scan region 212 is, as discussed above, determined based on the result of the coarse scan of scan region 202. For example, based on the coarse scan of scan region 202, a relative velocity of the target objects 206 and 208 may exceed a threshold level. Thus, the scan region 212 is determined by the controller 112 to incorporate the target objects 206 and 208. The controller 112 then controls the beam steering device 104 to scan only the scan points 214 in the scan region 212.

FIG. 2C shows an illustrative non-uniform scan point beam steering methodology to scan FOV 106 in accordance with various examples. In the example shown in FIG. 2C, the FOV 106 includes a scan region 222. Within the scan region 222 is target objects 208 and 210 while target object 206 is within the FOV 106, but outside the scan region 222. In other words, the scan region 222 is focused on target objects 208 and 210. Due to the capability of the beam steering device 104 to steer the optical waveforms 152 to any location within the FOV 106 at any time, the scan region 222 need not be uniform, but may be any shape (e.g., the shape of scan region 222) enabling the system 100 to focus on specific objects (e.g., target objects 208 and 210) with the FOV 106. In the example shown in FIG. 2C, the scan region 222 is a non-uniform scan region that covers less than half of the FOV 106. Additionally, the non-uniform scan region 222 includes two separate discontinuous (i.e., they do not overlap) scan regions 226 and 228. The scan region 228 includes only the target object 208 while the scan region 226 includes only the target object 210. This capability enables the system 100 to track independent objects (target objects 208 and 210) independently without the need to waste scan points on unwanted regions.

Like the scan region 202 and 212, the scan region 222 includes multiple scan points 224 and 230. However, the scan points 224 do not cover the entire scan region 222. Instead, the scan points 224 cover the entire scan region 228 while the scan points 230 cover the entire scan region 226. All of the scan points 224 and 230 are scanned and distances to the target objects 208 and 210 are determined. Because the scan region 222 is relatively small (e.g., includes less than half of the FOV 106 and is less than half the size of scan region 202), in some embodiments, a fine scan is performed. In other words, the scan of scan region 222 is at a relatively high image resolution (e.g., the scan points 224 and 230 are spaced relatively close to one another with a relatively high density). The fine scan of the scan region 222 then, in an embodiment, is conducted one or more additional times at a relatively high frame rate (e.g., a higher frame rate than the frame rate used during the coarse scan). Thus, relative movement of objects within the scan region 222 may be determined with greater accuracy than with the coarse scan of scan region 202 discussed above. Furthermore, a higher resolution “image” of the scan region 222 is obtained. In some embodiments, different scan regions within the non-uniform scan region (e.g., the scan regions 226 and 228) are scanned with different frame rates and/or at different resolutions. For example, the frame rate of scan region 226 can be higher than the frame rate of scan region 228. Similarly, the scan points 224 may be spaced closer to one another than the scan points 230 to provide higher resolution.

In some embodiments, the scan region 222 is, as discussed above, determined based on the result of the coarse scan of scan region 202. For example, based on the coarse scan of scan region 202, a relative velocity of the target objects 208 and 210 may exceed a threshold level. Thus, the scan region 222 is determined by the controller 112 to incorporate the target objects 208 and 210. The controller 112 then controls the beam steering device 104 to scan only the scan points 224 and 230 in the scan region 222. In some embodiments, the non-uniform scan regions can be updated, by the controller 112, based on the tracking of the objects in those regions. For example, the scan region 222 can be determined based on the result of a previous fine scan of a non-uniform scan region. The controller 112 can track the target objects 208 and 210 utilizing a non-uniform scan and adjust the non-uniform scan regions based on the relative track of those target objects.

As shown above in FIGS. 1 and 2A-C, the system 100 allows for the control of scan pitch which controls the number of scan points in the FOV 106 to scan, the frame rate, and provides individual control of the scan within the FOV 106. Thus, at all times, the location of each scan point is controlled.

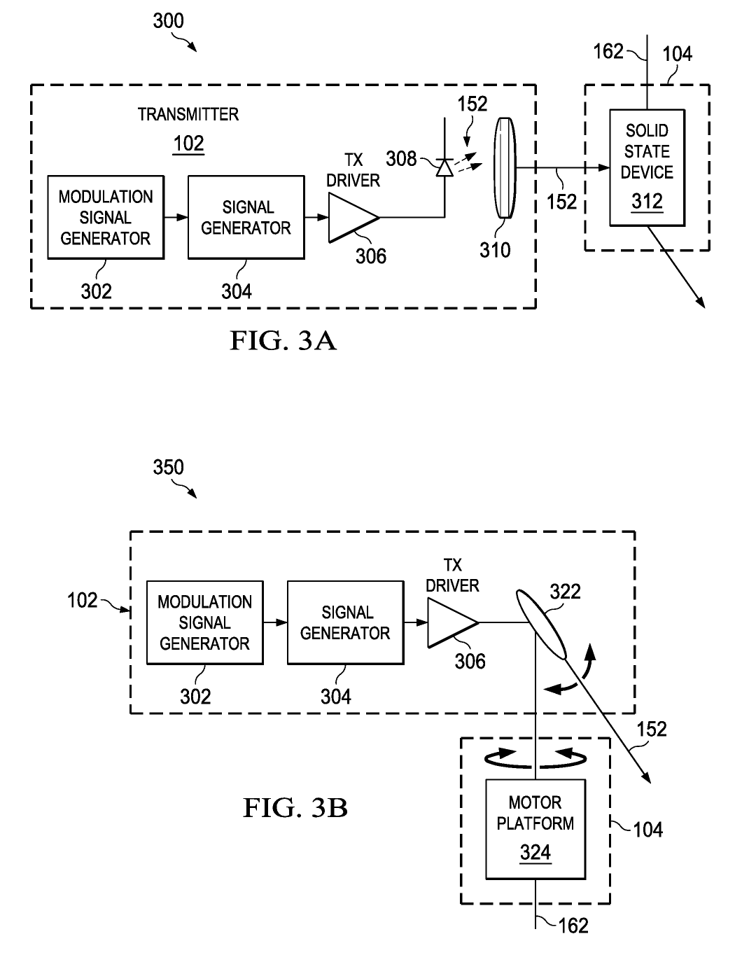

FIG. 3A shows an illustrative transmitting system 300 for distance measuring system 100 utilizing a solid state device 312 as the beam steering device 104 in accordance with various examples. The transmitting system 300 includes transmitter 102 and solid state device 312. The transmitter 102, in an embodiment, includes a modulation signal generator 302, a signal generator 304, a transmission driver 306, a laser diode 308, and a set of optics 310. The modulation signal generator 302 is configured to provide a phase, frequency, amplitude, and/or position modulation reference signal. The signal generator 304 is configured to generate pulse sequences using the reference signal from the modulation signal generator 302. In some embodiments, the modulation signal generator 302 is configured to generate single tones (i.e. continuous waves), single tones with phase modulation (e.g. phase shift keying), single tones with amplitude modulation (e.g. amplitude shift keying), multiple tones with fixed frequencies (e.g. frequency shift keying), signals with frequency modulation over a narrowband frequency range (e.g. chirps), and/or signals with narrowband, pulse position modulation. The transmit driver 306 generates a current drive signal to operate an optical transmitter such as laser diode 308. In other words, the modulation signal modulates the intensity of the light transmitted by laser diode 308 during the pulse. The signal generator 304 serves as a pulse sequence generator using the modulation signal as a reference. The set of optics 310 is configured to direct (e.g., focus) the optical waveforms 152 (e.g., the modulated light signals) to the solid state device 312. As discussed above, the solid state device 312 is configured to steer the optical waveforms 152 to scan points within the FOV 106.

FIG. 3B shows an illustrative transmitting system 350 for an optical distance measuring system 100 utilizing motorized platform 324 attached to a laser 322 as the beam steering device 104 in accordance with various examples. The transmitting system 350 includes transmitter 102 and motorized platform 324. The transmitter 102, in an embodiment, includes modulation signal generator 302, signal generator 304, transmission driver 306, and laser diode 322. The modulation signal generator 302, signal generator 304, and transmission driver 306 are configured, as discussed above under FIG. 3A, to generate a current drive signal to operate the laser 322. The motorized platform 324 controls the rotation of the laser 322 around a vertical axis and the vertical pitch of the laser base on the control signal 162 received from the controller 112. In this way, the laser 322 is configured to steer the optical waveforms 152 to scan points within the FOV 106.

FIG. 3C shows an illustrative transmitting system 375 for an optical distance measuring system 100 utilizing rotatable mirror 334 as the beam steering device 104 in accordance with various examples. The transmitting system 375 includes transmitter 102 and rotatable mirror 334. The transmitter 102, in an embodiment, includes modulation signal generator 302, signal generator 304, transmission driver 306, and laser 322. The modulation signal generator 302, signal generator 304, and transmission driver 306 are configured, as discussed above under FIGS. 3A and 3B, to generate a current drive signal to operate the laser 322. The laser 322 is configured to generate the optical waveforms 152 and direct the optical waveforms 152 to the rotatable mirror 334. The controller 112, through the control signal 162, controls the rotation of the mirror around a vertical axis and the vertical pitch of the mirror. The rotatable mirror 334 reflects the optical waveforms 152 to the FOV 106. In this way, the rotatable mirror 334 is configured to steer the optical waveforms 152 to scan points within the FOV 106.

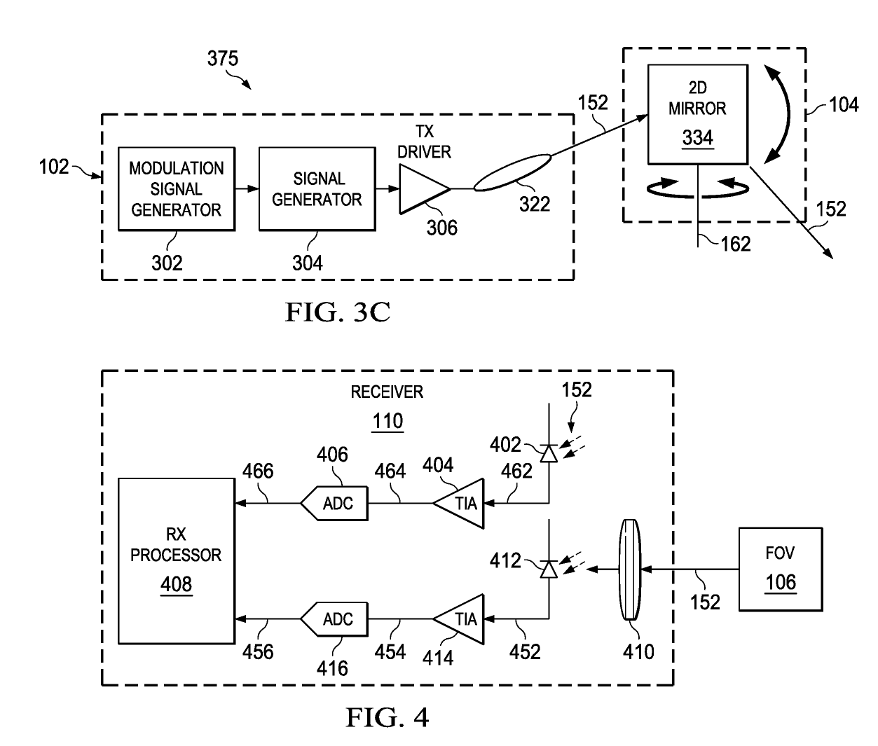

FIG. 4 shows an illustrative optical receiver 110 for distance measuring system 100 in accordance with various examples. The receiver 110 includes, in an embodiment, a set of optics 410, two photodiodes 402 and 412, two trans-impedance amplifiers (TIAs) 404 and 414, two analog-to-digital converters (ADCs) 406 and 416, and a receiver processor 408. As discussed above, in an embodiment, the reflected optical waveforms 152 are received by the receiver 110 from the FOV 106. The set of optics 410, in an embodiment, receives the each reflected optical waveform 152. The set of optics 410 directs (e.g., focuses) each reflected optical waveform 152 to the photodiode 412. The photodiode 412 is configured to receive each reflected optical waveform 152 and convert each reflected optical waveform 152 into current received signal 452 (a current that is proportional to the intensity of the received reflected light). TIA 414 is configured to receive current received signal 452 and convert the current received signal 452 into a voltage signal, designated as voltage received signal 454, that corresponds with the current received signal 452. ADC 416 is configured to receive the voltage received signal 454 and convert the voltage received signal 454 from an analog signal into a corresponding digital signal, designated as digital received signal 456. Additionally, in some embodiments, the current received signal 452 is filtered (e.g., band pass filtered) prior to being received by the TIA 414 and/or the voltage received signal 454 is filtered prior to being received by the ADC 416. In some embodiments, the voltage received signal 454 may be received by a time to digital converter (TDC) (not shown) to provide a digital representation of the time that the voltage received signal 454 is received.

Photodiode 402, in an embodiment, receives each optical waveform 152, or a portion of each optical waveform 152, directly from the transmitter 102 and converts each optical waveform 152 into current reference signal 462 (a current that is proportional to the intensity of the received light directly from transmitter 102). TIA 404 is configured to receive current reference signal 462 and convert the current reference signal 462 into a voltage signal, designated as voltage reference signal 464, that corresponds with the current reference signal 462. ADC 406 is configured to receive the voltage reference signal 464 and convert the voltage reference signal 464 from an analog signal into a corresponding digital signal, designated as digital reference signal 466. Additionally, in some embodiments, the current reference signal 462 is filtered (e.g., band pass filtered) prior to being received by the TIA 404 and/or the voltage reference signal 464 is filtered prior to being received by the ADC 406. In some embodiments, the voltage reference signal 464 may be received by a TDC (not shown) to provide a digital representation of the time that the voltage reference signal 464 is received.

The processor 408 is any type of processor, controller, microcontroller, and/or microprocessor with an architecture optimized for processing the digital received signal 456 and/or the digital reference signal 466. For example, the processor 408 may be a digital signal processor (DSP), a central processing unit (CPU), a reduced instruction set computing (RISC) core such as an advanced RISC machine (ARM) core, a mixed signal processor (MSP), etc. In some embodiments, the processor 408 is a part of the controller 112. The processor 408, in an embodiment, acts to demodulate the digital received signal 456 and the digital reference signal 466. In some embodiments, the processor 408 may also receive the digital representation of the times that the voltage received signal 456 and the digital reference signal 466 were received. The processor 408 then determines, in an embodiment, the distance to one or more of objects, such as target objects 206, 208, and/or 210 by, as discussed above, performing a correlation function using the reference signal and the received signal. A peak in the correlation function corresponds to the time delay of each received reflected optical waveform 152 (i.e., the TOF). The distance to the objects within the FOV 106 can be estimated using the formula discussed above. In other embodiments, an FFT is performed on the received digital signal 456. A phase of the tone then is used to estimate the delay (i.e., TOF) in the received signals. The distance then can be estimated using the formula discussed above.

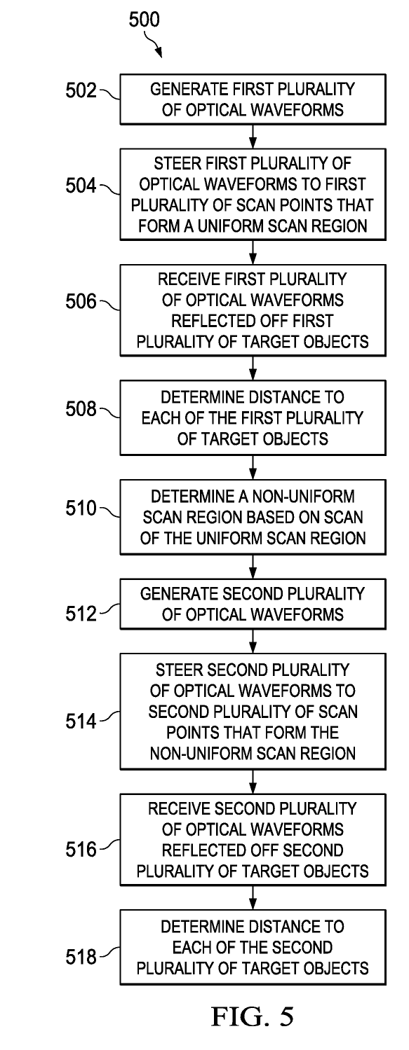

FIG. 5 shows an illustrative flow diagram of a method 500 for determining a distance to a plurality of target objects in accordance with various examples. Though depicted sequentially as a matter of convenience, at least some of the actions shown can be performed in a different order and/or performed in parallel. Additionally, some embodiments may perform only some of the actions shown. In some embodiments, at least some of the operations of the method 500, as well as other operations described herein, is performed by the transmitter 102 (including the modulation signal generator 302, signal generator 304, transmission driver 306, laser diode 308, laser 322, and/or the set of optics 310), the beam steering device 104 (including the solid state device 312, the motorized platform 324, and/or the rotatable mirror 334) and/or the receiver 110 (including the set of optics 410, photodiodes 402 and/or 412, TIAs 404 and/or 414, ADCs 406 and/or 416, and/or processor 408) and implemented in logic and/or by a processor executing instructions stored in a non-transitory computer readable storage medium.

The method 500 begins in block 502 with generating a first plurality of optical waveforms. For example, the transmitter 102 generates optical waveforms 152. In block 504, the method 500 continues with steering the first plurality of optical waveforms to a first plurality of scan points that form a uniform scan region. For example, the beam steering device 104 is configured to steer the optical waveforms 152 to the uniform scan region 202. More particularly, each of the first plurality of optical waveforms is directed to a different scan point 204 within the scan region 202 to scan the scan region 202.

The method 500 continues in block 506 with receiving the first plurality of optical waveforms reflected off a first plurality of target objects. For example, the receiver 110 receives the reflected optical waveforms 152 after being reflected off objects within the scan region 202. The method 500 continues in block 508 with determining the distance to each of the first plurality of target objects based on the TOF of each reflected optical waveform of the first plurality of optical waveforms. For example, the receiver 110 converts each reflected optical waveform 152 into a received electrical signal, such as received digital signal 456, and determines the TOF of each reflected optical waveform 152 based on a comparison between a reference signal corresponding to the optical waveform 152 received directly from the transmitter 102 with the received electrical signal. The distance then is determined based on the TOF.

The method 500 continues in block 510 with determining a non-uniform scan region based on the scan of the uniform scan region. For example, the controller 112 receives the distance measurement results from the uniform scan region and, based on the results (e.g., determined velocity of target objects within the scan region 202), determines a non-uniform scan region (e.g., scan regions 212 and/or 222) within the FOV 106 to scan.

In block 512, the method 500 continues with generating a second plurality of optical waveforms. For example, the transmitter 102 generates a second set of optical waveforms 152. In block 514, the method 500 continues with steering the second plurality of optical waveforms to a second plurality of scan points that form a non-uniform scan region. For example, the beam steering device 104 is configured to steer the optical waveforms 152 to the non-uniform scan region 212 and/or 222. More particularly, each of the second plurality of optical waveforms is directed to a different scan point 214 within the scan region 212 and/or scan point 224, 230 to scan the scan region 222.

The method 500 continues in block 516 with receiving the second plurality of optical waveforms reflected off a second plurality of target objects. The second plurality of target objects is included in the first plurality of target objects. For example, the receiver 110 receives the reflected optical waveforms 152 after being reflected off objects within the scan region 212 and/or 222. The method 500 continues in block 518 with determining the distance to each of the second plurality of target objects based on the TOF of each reflected optical waveform of the second plurality of optical waveforms. For example, the receiver 110 converts each reflected optical waveform 152 into a received electrical signal, such as received digital signal 456, and determines the TOF of each reflected optical waveform 152 based on a comparison between a reference signal corresponding to the optical waveform 152 received directly from the transmitter 102 with the received electrical signal. The distance then is determined based on the TOF.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. An optical distance measuring system, comprising:
a transmitter configured to generate a first plurality of optical waveforms;
a beam steering device configured to steer the first plurality of optical waveforms to a first plurality of scan points that form a non-uniform scan region within a field of view (FOV); and
a receiver configured to receive the first plurality of optical waveforms reflected off of a first plurality of target objects within the non-uniform scan region and determine a distance to each target object of the first plurality of target objects based on a time of flight from the transmitter to each target object of the first plurality of target objects and back to the receiver.

2. The optical distance measuring system of claim 1, wherein:
the transmitter is further configured to generate a second plurality of optical waveforms;
the beam steering device is further configured to steer the second plurality of optical waveforms to a second plurality of scan points that form a uniform scan region within the FOV, the uniform scan region including the non-uniform scan region; and
the receiver configured to receive the second plurality of optical waveforms reflected off of a second plurality of target objects within the FOV and determine a distance to each target object of the second plurality of target objects based on a time of flight from the transmitter to each target object of the second plurality of target objects, the second plurality of target objects including the first plurality of target objects.

3. The optical distance measuring system of claim 2, further comprising a controller configured to control the beam steering device to steer the first plurality of optical waveforms to the first plurality of scan points and the second plurality of optical waveforms to the second plurality of scan points.

4. The optical distance measuring system of claim 3, wherein the controller is further configured to determine the non-uniform scan region based on the scan of the uniform scan region.

5. The optical distance measuring system of claim 2, wherein a frame rate of the scan of the uniform scan region is less than a frame rate of the non-uniform scan region.

6. The optical distance measuring system of claim 2, wherein an image resolution of the scan of the uniform scan region is less than an image resolution of the non-uniform scan region.

7. The optical distance measuring system of claim 1, wherein the non-uniform scan region includes more than one discontinuous scan region.

8. The optical distance measuring system of claim 1, wherein the beam steering device is a solid state device.

9. The optical distance measuring system of claim 9, wherein the solid state device is a digital micromirror device.

10. The optical distance measuring system of claim 9, wherein the solid state device is a phased array device.

11. An optical transmitting system for distance measuring, comprising:
a signal generator configured to generate a first plurality of pulse sequences;
a laser diode coupled to the signal generator, the laser diode configured to generate a first plurality of optical waveforms that correspond with the first plurality of pulse sequences; and
a beam steering device configured to receive the first plurality of optical waveforms and steer the first plurality of optical waveforms to a first plurality of scan points that form a non-uniform scan region within a field of view (FOV).

12. The optical transmitting system of claim 11, wherein:
the signal generator is further configured to generate a second plurality of pulse sequences;
the laser diode is further configured to generate a second plurality of optical waveforms that correspond with the second plurality of pulse sequences; and
the beam steering device is further configured to receive the second plurality of optical waveforms and steer the second plurality of optical waveforms to a second plurality of scan points that form a uniform scan region within the FOV, the uniform scan region including the non-uniform scan region.

13. The optical transmitting system of claim 12, wherein the first plurality of scan points is determined based on the scan of the uniform scan region.

14. The optical transmitting system of claim 12, wherein a frame rate of the scan of the uniform scan region is less than a frame rate of the non-uniform scan region.

15. The optical transmitting system of claim 11, wherein the non-uniform scan region includes more than one discontinuous scan region.

16. The optical transmitting system of claim 11, wherein the beam steering device is a solid state device.

17. A method for determining a distance to a plurality of target objects, comprising:
generating a first plurality of optical waveforms;
steering the first plurality of optical waveforms to a first plurality of scan points that form a uniform scan region within a field of view (FOV);
in response to the scan of the uniform scan region, determining a non-uniform scan region within the FOV;
generating a second plurality of optical waveforms; and
steering the second plurality of optical waveforms to a second plurality of scan points that form the non-uniform scan region.

18. The method of claim 17, further comprising:
receiving the first plurality of optical waveforms reflected off of a first plurality of target objects within the uniform scan region; and
determining a distance to each of the first plurality of target objects based on a time of flight of the first plurality of optical waveforms.

19. The method of claim 18, further comprising:
receiving the second plurality of optical waveforms reflected off of a second plurality of target objects within the non-uniform scan region, the first plurality of target objects including the second plurality of target objects; and
determining a distance to each of the second plurality of target objects based on a time of flight of the second plurality of optical waveforms.

20. The method of claim 17, wherein the non-uniform scan region includes at least two discontinuous scan regions within the uniform scan region.
